(19) United States
(12) Patent Application Publication
(10) Pub. No.: US 2019/0313126 A1
(43) Pub. Date: Oct. 10, 2019

(54) Coding and Decoding Methods and Apparatuses Based on Template Matching

(71) Applicant: Huawei Technologies Co., Ltd., Shenzhen (CN)

(72) Inventor: Yongbing Lin, Beijing (CN)

(21) Appl. No.: 16/448,377

(22) Filed: Jun. 21, 2019

Related U.S. Application Data
(63) Continuation of application No. PCT/CN2016/112198, filed on Dec. 26, 2016.

(51) Int. Cl. H04N 19/91; H04N 19/124; H04N 19/52; H04N 19/615; H04N 19/105; H04N 19/176

(52) U.S. Cl. CPC H04N 19/91; H04N 19/124; H04N 19/176; H04N 19/615; H04N 19/105; H04N 19/52

(57) ABSTRACT

A coding method based on template matching includes determining a prediction mode of a to-be-coded unit, performing intra-frame prediction or inter-frame prediction on the to-be-coded unit based on the prediction mode to obtain a prediction residual of the to-be-coded unit, when the prediction mode is a template matching mode, transforming the prediction residual using target transform to obtain transform coefficients, where coefficients in row 1 of a transform basis matrix of the target transform are distributed in ascending order from left to right, or coefficients in column 1 are distributed in ascending order from top to bottom, and performing quantization and entropy coding on the transform coefficients to generate a code stream.

### CROSS-REFERENCE TO RELATED APPLICATIONS

This application is a continuation of International Application No. PCT/CN2016/112198, filed on Dec. 26, 2016, the disclosure of which is hereby incorporated by reference in its entirety.

### TECHNICAL FIELD

This application relates to the field of video image technologies, and in particular, to coding and decoding methods and apparatuses based on template matching.

### BACKGROUND

A compression rate is a primary performance indicator of a video coding and compression technology, to implement transmission of highest-quality video content using lowest bandwidth. The compression rate is increased by eliminating redundant information of video content. For all mainstream technical frameworks of a video coding and compression standard, a hybrid video coding scheme based on an image block is used. Main video coding technologies include prediction, transform and quantization, and entropy coding, where spatial correlation and time correlation are eliminated using the prediction technology, frequency domain correlation is eliminated using the transform and quantization technology, and redundancy of information between code words is further eliminated using the entropy coding technology.

As the video coding and compression rate is continuously increasing, motion information in a coding code stream accounts for an increasing ratio. The motion information may be derived from a decoder side using a motion information prediction technology based on template matching (TM). In this way, the motion information does not need to be transferred, thereby greatly saving coded bits and increasing the compression rate. The TM-based motion information prediction technology becomes one of candidate technologies of a next-generation video coding standard.

For existing transform processing on a prediction residual generated based on template matching, discrete cosine transform (DCT) is used. As most common transform in video coding, DCT has relatively desirable energy centralization, and has a fast algorithm for implementation. However, for DCT, an energy distribution feature of the template matching-based prediction residual is not considered. DCT is suitable only for flat residual energy distribution, but the prediction residual obtained based on template matching does not have a flat energy distribution feature. Therefore, DCT is not suitable for the prediction residual obtained based on template matching.

### SUMMARY

Embodiments of this application provide coding and decoding methods and apparatuses based on template matching, to select a suitable transform manner to process a residual generated based on template matching, so that complexity is reduced while a transform effect is ensured, to improve coding and decoding efficiency.

According to a first aspect, a coding method based on template matching is provided, including determining a prediction mode of a to-be-coded unit, performing intra-frame prediction or inter-frame prediction on the to-be-coded unit based on the prediction mode, to obtain a prediction residual of the to-be-coded unit, when the prediction mode is a template matching mode, transforming the prediction residual using target transform, to obtain transform coefficients, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-coded unit, matching and search based on a current template to obtain a predicted value of the to-be-coded unit, the predicted value is used to calculate the prediction residual, and the current template includes a preset quantity of a plurality of reconstructed pixels at preset positions in a neighboring region of the to-be-coded unit, and performing quantization and entropy coding on the transform coefficients, to generate a code stream.

A beneficial effect is as follows. When coding is performed on a coder side, an energy distribution feature of the template matching-based prediction residual is similar to a feature of the transform basis matrix of the target transform, so that correlation can be well eliminated, and a transform effect and a coding effect are improved. In addition, compared with a multi-transform selection technology in the prior art, index information of the selected target transform does not need to be written to a code stream, so that bit overheads can be reduced during coding.

With reference to the first aspect, in a possible design, the target transform includes Discrete Sine Transform (DST) of type VII (DST-VII) transform, where a transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{\partial \cdot ( 2 i + 1 ) \cdot ( j + 1 )}{2 N + 1} ) ,$$

where i and j represent a row index and a column index respectively, and N represents a quantity of transform points.

A beneficial effect is as follows. A feature of the transform basis function of the DST-VII transform conforms to an energy distribution feature of the template matching-based prediction residual, so that a relatively desirable transform effect can be obtained, and coding quality and coding efficiency can be further improved.

With reference to the first aspect, in a possible design, the transforming the prediction residual using target transform includes performing the transform according to the following expression, C=T1×I×T2, where I represents a matrix of the prediction residual. T1 represents a first form of the transform basis matrix of the target transform, T2 represents a second form of the transform basis matrix of the target transform, and C represents a matrix of the transform coefficients.

With reference to the first aspect, in a possible design, the first form and the second form are in a transposed matrix relationship.

With reference to the first aspect, in a possible design, when the prediction mode is not the template matching mode, the method further includes performing DST or DCT on the prediction residual, to obtain the transform coefficients.

A beneficial effect is as follows. When the prediction mode is not the template matching mode, DST or DCT can be adaptively performed, to improve a transform effect.

According to a second aspect, a coding method based on template matching is provided, including determining a prediction mode of a to-be-coded unit, performing intra-frame prediction or inter-frame prediction on the to-be-coded unit based on the prediction mode, to obtain a prediction residual of the to-be-coded unit, when the prediction mode is a template matching mode and a size of the to-be-coded unit is less than a preset size, transforming the prediction residual using target transform, to obtain transform coefficients, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-coded unit, matching and search based on a current template to obtain a predicted value of the to-be-coded unit, the predicted value is used to calculate the prediction residual, and the current template includes a preset quantity of a plurality of reconstructed pixels at preset positions in a neighboring region of the to-be-coded unit, and performing quantization and entropy coding on the transform coefficients, to generate a code stream.

A beneficial effect is as follows. When coding is performed on a coding side, for a small-sized prediction residual block based on template matching, an energy distribution feature of the template matching-based prediction residual is similar to a feature of the transform basis matrix of the target transform, so that correlation can be well eliminated, and a transform effect and a coding effect are improved. In addition, compared with a multi-transform selection technology in the prior art, index information of the selected target transform does not need to be written to a code stream, so that bit overheads can be reduced during coding.

With reference to the second aspect, in a possible design, the target transform includes DST-VII transform, where a transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

A beneficial effect is as follows. A small-sized prediction residual block is transformed using the determined DST-VII transform, and a feature of the transform basis function of the DST-VII transform conforms to an energy distribution feature of template matching-based prediction residual of the small-sized block, so that a desirable transform effect can be obtained, and coding quality and coding efficiency can be further improved.

With reference to the second aspect, in a possible design, when the prediction mode is not the template matching mode or the size of the to-be-coded unit is not less than the preset size, DCT or DST is performed on the prediction residual, to obtain the transform coefficients.

A beneficial effect is as follows. When the prediction mode is not the template matching mode or the size of the to-be-coded unit is not less than the preset size, DST or DCT can be adaptively performed, to improve a transform effect.

According to a third aspect, a decoding method based on template matching is provided, including obtaining a prediction mode of a to-be-decoded unit from a code stream, performing intra-frame prediction or inter-frame prediction on the to-be-decoded unit based on the prediction mode, to obtain a predicted value of the to-be-decoded unit, obtaining residual coefficients from the code stream, where the residual coefficients are used to represent a prediction residual of the to-be-decoded unit, dequantizing the residual coefficients, to obtain transform coefficients, when the prediction mode is a template matching mode, performing inverse transform of target transform on the transform coefficients, to obtain the prediction residual, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-decoded unit, matching and search based on a current template to obtain a predicted value of the to-be-decoded unit, and the current template includes a preset quantity of a plurality of reconstructed pixels at preset positions in a neighboring region of the to-be-decoded unit, and adding up the predicted value and the prediction residual to obtain a reconstruction value of the to-be-decoded unit.

A beneficial effect is as follows. When decoding is performed on a decoder side, an energy distribution feature of the template matching-based prediction residual is similar to a feature of the transform basis matrix of the target transform, so that correlation can be well eliminated, a decoding effect is improved, and further decoding quality is improved. In addition, compared with the prior art, index information of the target transform does not need to be obtained from the code stream to perform inverse transform of the target transform, so that bit overheads can be reduced during coding and decoding efficiency is improved.

With reference to the third aspect, in a possible design, the target transform includes DST-VII transform, where a transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

With reference to the third aspect, in a possible design, the performing inverse transform of target transform on the transform coefficients includes performing the inverse transform according to the following expression, C=T1×I×T2, where I represents a matrix of the transform coefficients, T1 represents a first form of the transform basis matrix of the target transform, T2 represents a second form of the transform basis matrix of the target transform, and C represents a matrix of the prediction residual.

With reference to the third aspect, in a possible design, the first form and the second form are in a transposed matrix relationship.

With reference to the third aspect, in a possible design, when the prediction mode is not the template matching mode, the method further includes performing inverse transform of DST or inverse transform of DCT on the transform coefficients, to obtain the prediction residual.

A beneficial effect is as follows. When the prediction mode is not the template matching mode, the inverse transform of the DST or the inverse transform of the DCT is performed on the transform coefficients, and either of the two transform manners is adaptively selected, to reduce complexity and improve transform efficiency.

According to a fourth aspect, a decoding method based on template matching is provided, including obtaining a prediction mode of a to-be-decoded unit from a code stream, performing intra-frame prediction or inter-frame prediction on the to-be-decoded unit based on the prediction mode, to obtain a predicted value of the to-be-decoded unit, obtaining residual coefficients from the code stream, where the residual coefficients are used to represent a prediction residual of the to-be-decoded unit, dequantizing the residual coefficients, to obtain transform coefficients, when the prediction mode is a template matching mode and a size of the to-be-decoded unit is less than a preset size, performing inverse transform of target transform on the transform coefficients, to obtain the prediction residual, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-decoded unit, matching and search based on a current template to obtain a predicted value of the to-be-decoded unit, and the current template includes a preset quantity of a plurality of reconstructed pixels at preset positions in a neighboring region of the to-be-decoded unit, and adding up the predicted value and the prediction residual to obtain a reconstruction value of the to-be-decoded unit.

A beneficial effect is as follows. When decoding is performed on a decoder side, an energy distribution feature of a template matching-based prediction residual of a small-sized block is similar to a feature of the transform basis matrix of the target transform, so that correlation can be well eliminated, a decoding effect is improved, and further decoding quality is improved. In addition, compared with a multi-transform selection technology in the prior art, index information of the target transform does not need to be obtained from the code stream to perform the inverse transform of the target transform, so that bit overheads can be reduced during coding and decoding efficiency is improved.

With reference to the fourth aspect, in a possible design, the target transform includes DST-VII transform, where a transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

With reference to the fourth aspect, in a possible design, the performing inverse transform of target transform on the transform coefficients includes performing the inverse transform according to the following expression C=T1×I×T2, where I represents a matrix of the transform coefficients, T1 represents a first form of the transform basis matrix of the target transform, T2 represents a second form of the transform basis matrix of the target transform, and C represents a matrix of the prediction residual.

With reference to the fourth aspect, in a possible design, the first form and the second form are in a transposed matrix relationship.

With reference to the fourth aspect, in a possible design, when the prediction mode is not the template matching mode or the size of the to-be-decoded unit is not less than the preset size, the method further includes performing inverse transform of DST or inverse transform of DCT on the transform coefficients, to obtain the prediction residual.

A beneficial effect is as follows. When the prediction mode is not the template matching mode, the inverse transform of the DST or the inverse transform of the DCT is performed on the transform coefficients, and either of the two transform manners is adaptively selected, to reduce complexity and improve transform efficiency.

With reference to the fourth aspect, in a possible design, before the performing inverse transform of DST or inverse transform of DCT on the transform coefficients, the method further includes obtaining an index from the code stream, where the index is used to represent that the inverse transform is performed using the DST or the DCT.

With reference to the fourth aspect, in a possible design, the preset size includes the following case a length and a width of the to-be-decoded unit each are 2, 4, 8, 16, 32, 64, 128, or 256, or a long side of the to-be-decoded unit is 2, 4, 8, 16, 32, 64, 128, or 256, or a short side of the to-be-decoded unit is 2, 4, 8, 16, 32, 64, 128, or 256.

According to a fifth aspect, a coding apparatus based on template matching is provided, including a determining unit, configured to determine a prediction mode of a to-be-coded unit, a prediction unit, configured to perform intra-frame prediction or inter-frame prediction on the to-be-coded unit based on the prediction mode, to obtain a prediction residual of the to-be-coded unit, a transform unit, configured to, when the prediction mode is a template matching mode, transform the prediction residual using target transform, to obtain transform coefficients, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-coded unit, matching and search based on a current template to obtain a predicted value of the to-be-coded unit, the predicted value is used to calculate the prediction residual, and the current template includes a preset quantity of a plurality of reconstructed pixels at preset positions in a neighboring region of the to-be-coded unit, and a coding unit, configured to perform quantization and entropy coding on the transform coefficients, to generate a code stream.

With reference to the fifth aspect, in a possible design, the target transform includes DST-VII transform, where a transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

With reference to the fifth aspect, in a possible design, the transform unit transforms the prediction residual using the target transform and according to the following expression C=T1×I×T2, where I represents a matrix of the prediction residual, T1 represents a first form of the transform basis matrix of the target transform, T2 represents a second form of the transform basis matrix of the target transform, and C represents a matrix of the transform coefficients.

With reference to the fifth aspect, in a possible design, the first form and the second form are in a transposed matrix relationship.

With reference to the fifth aspect, in a possible design, the transform unit is further configured to, when the prediction mode is not the template matching mode, perform DST or DCT on the prediction residual, to obtain the transform coefficients.

According to a sixth aspect, a coding apparatus based on template matching is provided, including a determining unit, configured to determine a prediction mode of a to-be-coded unit, a prediction unit, configured to perform intra-frame prediction or inter-frame prediction on the to-be-coded unit based on the prediction mode, to obtain a prediction residual of the to-be-coded unit, a transform unit, configured to, when the prediction mode is a template matching mode and a size of the to-be-coded unit is less than a preset size, transform the prediction residual using target transform, to obtain transform coefficients, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-coded unit, matching and search based on a current template to obtain a predicted value of the to-be-coded unit, the predicted value is used to calculate the prediction residual, and the current template includes a preset quantity of a plurality of reconstructed pixels at preset positions in a neighboring region of the to-be-coded unit, and a coding unit, configured to perform quantization and entropy coding on the transform coefficients, to generate a code stream.

With reference to the sixth aspect, in a possible design, the target transform includes DST-VII transform, where a transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

With reference to the sixth aspect, in a possible design, the transform unit is further configured to, when the prediction mode is not the template matching mode or the size of the to-be-coded unit is not less than the preset size, perform DCT or DST on the prediction residual, to obtain the transform coefficients.

According to a seventh aspect, a decoding apparatus based on template matching is provided, including an obtaining unit, configured to obtain a prediction mode of a to-be-decoded unit from a code stream, a prediction unit, configured to perform intra-frame prediction or inter-frame prediction on the to-be-decoded unit based on the prediction mode, to obtain a predicted value of the to-be-decoded unit, where the obtaining unit is further configured to obtain residual coefficients from the code stream, where the residual coefficients are used to represent a prediction residual of the to-be-decoded unit, a dequantization unit, configured to dequantize the residual coefficients, to obtain transform coefficients, an inverse transform unit, configured to, when the prediction mode is a template matching mode, perform inverse transform of target transform on the transform coefficients, to obtain the prediction residual, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-decoded unit, matching and search based on a current template to obtain a predicted value of the to-be-decoded unit, and the current template includes a preset quantity of a plurality of reconstructed pixels at preset positions in a neighboring region of the to-be-decoded unit, and a decoding unit, configured to add up the predicted value and the prediction residual to obtain a reconstruction value of the to-be-decoded unit.

With reference to the seventh aspect, in a possible design, the target transform includes DST-VII transform, where a transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

With reference to the seventh aspect, in a possible design, the inverse transform unit performs the inverse transform of the target transform on the transform coefficients according to the following expression C=T1×I×T2, where I represents a matrix of the transform coefficients. T1 represents a first form of the transform basis matrix of the target transform, T2 represents a second form of the transform basis matrix of the target transform, and C represents a matrix of the prediction residual.

With reference to the seventh aspect, in a possible design, the first form and the second form are in a transposed matrix relationship.

With reference to the seventh aspect, in a possible design, the inverse transform unit is further configured to, when the prediction mode is not the template matching mode, perform inverse transform of DST or inverse transform of DCT on the transform coefficients, to obtain the prediction residual.

According to an eighth aspect, a decoding apparatus based on template matching is provided, including an obtaining unit, configured to obtain a prediction mode of a to-be-decoded unit from a code stream, a prediction unit, configured to perform intra-frame prediction or inter-frame prediction on the to-be-decoded unit based on the prediction mode, to obtain a predicted value of the to-be-decoded unit, where the prediction unit is further configured to obtain residual coefficients from the code stream, and the residual coefficients are used to represent a prediction residual of the to-be-decoded unit, a dequantization unit, configured to dequantize the residual coefficients, to obtain transform coefficients, an inverse transform unit, configured to, when the prediction mode is a template matching mode and a size of the to-be-decoded unit is less than a preset size, perform inverse transform of target transform on the transform coefficients, to obtain the prediction residual, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-decoded unit, matching and search based on a current template to obtain a predicted value of the to-be-decoded unit, and the current template includes a preset quantity of a plurality of reconstructed pixels at preset positions in a neighboring region of the to-be-decoded unit, and a decoding unit, configured to add up the predicted value and the prediction residual to obtain a reconstruction value of the to-be-decoded unit.

With reference to the eighth aspect, in a possible design, the target transform includes DST-VII transform, where a transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

With reference to the eighth aspect, in a possible design, the inverse transform unit performs the inverse transform of the target transform on the transform coefficients according to the following expression C=T1×I×T2, where I represents a matrix of the transform coefficients. T1 represents a first form of the transform basis matrix of the target transform. T2 represents a second form of the transform basis matrix of the target transform, and C represents a matrix of the prediction residual.

With reference to the eighth aspect, in a possible design, the first form and the second form are in a transposed matrix relationship.

With reference to the eighth aspect, in a possible design, the inverse transform unit is further configured to, when the prediction mode is not the template matching mode or the size of the to-be-decoded unit is not less than the preset size, perform inverse transform of DST or inverse transform of DCT on the transform coefficients, to obtain the prediction residual.

With reference to the eighth aspect, in a possible design, the obtaining unit is further configured to, before the inverse transform of the DST or the inverse transform of the DCT is performed on the transform coefficients, obtain an index from the code stream, where the index is used to represent that the inverse transform is performed using the DST or the DCT.

With reference to the eighth aspect, in a possible design, the preset size includes the following case a length and a width of the to-be-decoded unit each are 2, 4, 8, 16, 32, 64, 128, or 256, or a long side of the to-be-decoded unit is 2, 4, 8, 16, 32, 64, 128, or 256, or a short side of the to-be-decoded unit is 2, 4, 8, 16, 32, 64, 128, or 256.

According to a ninth aspect, a coding device is provided, where the device includes a processor and a memory, the memory stores a computer readable program, and the processor runs the program in the memory, to implement the coding method in the first aspect or the second aspect.

According to a tenth aspect, a decoding device is provided, where the device includes a processor and a memory, the memory stores a computer readable program, and the processor runs the program in the memory, to implement the decoding method in the third aspect or the fourth aspect.

According to an eleventh aspect, a computer storage medium is provided, configured to store computer software instructions in the first aspect, the second aspect, the third aspect, and the fourth aspect, where the computer software instructions include a program designed to execute the foregoing aspects.

It should be understood that, technical solutions in the fifth aspect to the eleventh aspect of the embodiments of this application are consistent with technical solutions in the first aspect, the second aspect, the third aspect, and the fourth aspect of the embodiments of this application, and beneficial effects obtained by the aspects and corresponding implementable designs are similar, and details are not described again.

### BRIEF DESCRIPTION OF DRAWINGS

FIG. 1A is a schematic block diagram of a video coding and decoding apparatus or an electronic device.

FIG. 1B is a schematic diagram of a video coding apparatus according to an embodiment of this application.

FIG. 2 is a schematic block diagram of a video coding and decoding system.

FIG. 3 is a flowchart of a coding method based on template matching according to an embodiment of this application.

FIG. 4 is a schematic diagram of energy distribution of a template matching-based prediction residual of a to-be-coded unit.

FIG. 5 is a flowchart of a decoding method based on template matching according to an embodiment of this application.

FIG. 6 is a flowchart of a coding method based on template matching according to an embodiment of this application.

FIG. 7 is a flowchart of a decoding method based on template matching according to an embodiment of this application.

FIG. 8 is a structural diagram of a coding apparatus based on template matching according to an embodiment of this application.

FIG. 9 is a structural diagram of a coder based on template matching according to an embodiment of this application.

FIG. 10 is a structural diagram of a coding apparatus based on template matching according to an embodiment of this application.

FIG. 11 is a structural diagram of a coder based on template matching according to an embodiment of this application.

FIG. 12 is a structural diagram of a decoding apparatus based on template matching according to an embodiment of this application.

FIG. 13 is a structural diagram of a decoder based on template matching according to an embodiment of this application.

FIG. 14 is a structural diagram of a decoding apparatus based on template matching according to an embodiment of this application.

FIG. 15 is a structural diagram of a decoder based on template matching according to an embodiment of this application.

### DESCRIPTION OF EMBODIMENTS

The following clearly describes technical solutions in the embodiments of this application with reference to accompanying drawings in the embodiments of this application.

A procedure in which transform of a prediction residual is implemented based on template matching in existing video coding is shown as follows.

1. Perform template matching and search, to obtain motion information MV.

2. Obtain a predicted value of a current block using the motion information MV, and obtain a prediction residual using the obtained predicted value.

3. Transform the prediction residual.

4. Perform quantization and entropy coding on coefficients obtained after the transform, and write the processed coefficients into a code stream.

There are mainly two coding technologies in a block-based hybrid video coding framework.

(1) Inter-frame coding (Inter coding): A basic principle is to use time domain correlation, for example, to eliminate time domain correlation through motion-compensated prediction. During inter-frame coding, a reference frame is required for predictive coding, and a basic parameter is motion information, where a predicted value of a current block is obtained using the motion information, and the motion information may be obtained using the foregoing template matching method.

(2) Intra-frame coding (Intra coding): A basic principle is to use spatial correlation, for example, to eliminate spatial redundancy through intra-frame prediction (Intra prediction). The intra-frame coding is termed because predictive coding is performed using only information about a current frame in a coding process but not information about another frame. During intra-frame prediction, an adjacent pixel is usually used as a reference pixel to perform prediction on a current block. In addition, a predicted value may alternatively be obtained using the foregoing template matching method. In this case, template matching is performed inside a current coded image, to obtain the predicted value of the current block, unlike inter-frame prediction in which template matching is performed inside a reference image.

Prediction based on template matching may be applied to both intra-frame coding and inter-frame coding, and a prediction residual corresponding to the prediction based on template matching is referred to as a template matching-based prediction residual.

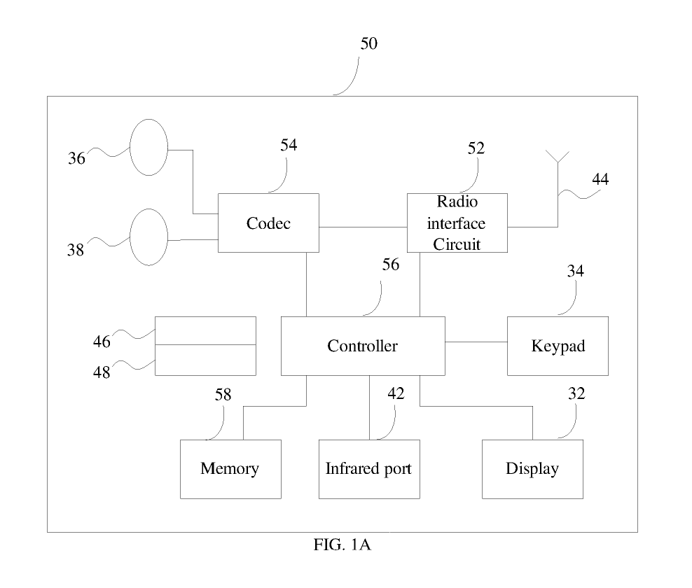

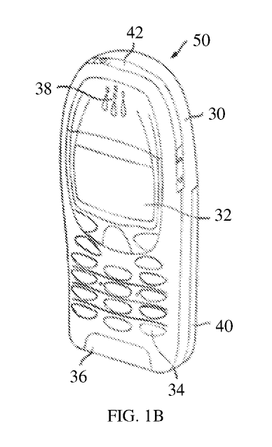

FIG. 1A is a schematic block diagram of a video coding and decoding apparatus 50 or an electronic device 50. The apparatus or the electronic device may be integrated into a codec in an embodiment of this application. FIG. 1B is a schematic diagram of a video coding apparatus according to an embodiment of this application. Units in FIG. 1A and FIG. 1B are described below.

The electronic device 50 may be, for example, a mobile terminal or user equipment in a wireless communications system. It should be understood that this embodiment of this application may be implemented in any electronic device or any apparatus that may need to code and decode, or code, or decode a video image.

The apparatus 50 may include a housing that is configured to house and protect a device. The apparatus 50 may further include a display 32 in a form of a liquid crystal display. In another embodiment of this application, the display may be any proper display suitable for displaying an image or a video. The apparatus 50 may further include a keypad 34. In another embodiment of this application, any proper data or user interface mechanism may be used. For example, a user interface may be implemented as a virtual keyboard or a data entry system, to serve as a part of a touch-sensitive display. The apparatus may include a microphone 36 or any proper audio input, and the audio input may be digital or analog signal input. The apparatus 50 may further include an audio output device. In this embodiment of this application, the audio output device may be any one of the following a headset 38, a speaker, or an analog audio or digital audio output device. The apparatus 50 may further include a battery 40. In another embodiment of this application, the device may be supplied with power by any proper mobile energy device, for example, a solar cell, a fuel cell, or a clockwork generator. The apparatus may further include an infrared port 42 configured to perform short-range line-of-sight communication with another device. In another embodiment, the apparatus 50 may further include any proper short-range communication solution, for example, BLUETOOTH wireless connection or a universal serial bus (USB)/firewire wired connection.

The apparatus 50 may include a controller 56 or a processor configured to control the apparatus 50. The controller 56 may be connected to a memory 58. In this embodiment of this application, the memory may store data in an image form and data in an audio form, and/or may store an instruction to be executed on the controller 56. The controller 56 may be further connected to a codec 54 suitable for coding and decoding audio and/or video data, or a codec 54 that implements coding and decoding under assistance of the controller 56.

The apparatus 50 may further include a card reader 48 and a smart card 46 that are configured to provide user information and that are suitable for providing authentication information used for network authentication and user authorization.

The apparatus 50 may further include a radio interface circuit 52. The radio interface circuit is connected to the controller and is suitable for generating, for example, a wireless communication signal for communication with a cellular communications network, a wireless communications system, or a wireless local area network. The apparatus 50 may further include an antenna 44. The radio interface circuit 52, the antenna is connected to the radio interface circuit 52 and is configured to send radio-frequency signals generated by the radio interface circuit 52 to other apparatuses (a plurality of other apparatuses), and receive radio frequency signals from the other apparatuses (a plurality of other apparatuses).

In some embodiments of this application, the apparatus 50 includes a camera capable of recording or detecting frames, and the codec 54 or the controller receives and processes these frames. In some embodiments of this application, the apparatus can receive to-be-processed video and image data from another device before transmitting and/or storing the data. In some embodiments of this application, the apparatus 50 may receive, through a wireless or wired connection, an image for coding or decoding.

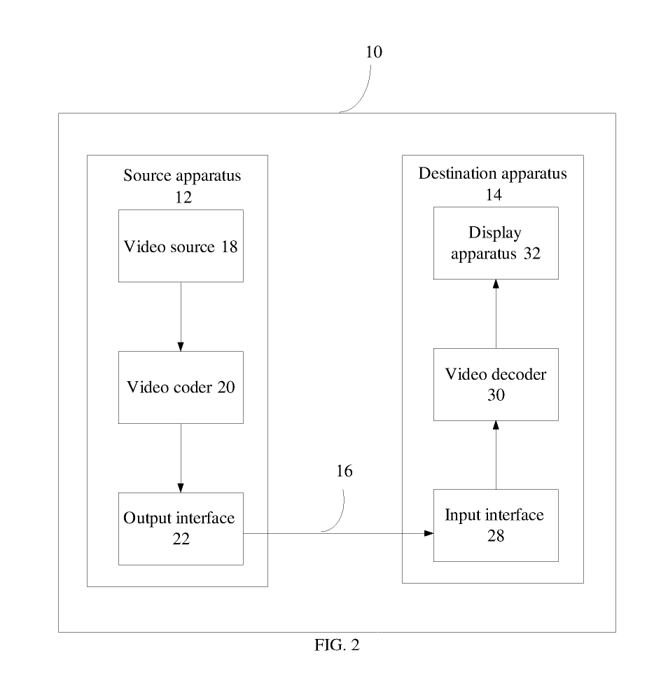

FIG. 2 is a schematic block diagram of another video coding and decoding system 10 according to an embodiment of this application. As shown in FIG. 2, the video coding and decoding system 10 includes a source apparatus 12 and a destination apparatus 14. The source apparatus 12 generates coded video data. Therefore, the source apparatus 12 may be referred to as a video coding apparatus or a video coding device. The destination apparatus 14 can decode the coded video data generated by the source apparatus 12. Therefore, the destination apparatus 14 may be referred to as a video decoding apparatus or a video decoding device. The source apparatus 12 and the destination apparatus 14 may be an instance of a video coding and decoding apparatus or a video coding and decoding device. The source apparatus 12 and the destination apparatus 14 may include a wide range of apparatuses, including a desktop computer, a mobile computing apparatus, a notebook (for example, laptop) computer, a tablet computer, a set-top box, a handheld phone such as a smartphone, a television set, a camera, a display apparatus, a digital media player, a video game console, an in-vehicle computer, or the like.

The destination apparatus 14 may receive, through a channel 16, coded video data from the source apparatus 12. The channel 16 may include one or more media and/or apparatuses capable of moving coded video data from the source apparatus 12 to the destination apparatus 14. In an instance, the channel 16 may include one or more communications media that enable the source apparatus 12 to directly transmit coded video data to the destination apparatus 14 in real time. In this instance, the source apparatus 12 may modulate the coded video data according to a communications standard (for example, a wireless communications protocol), and may transmit modulated video data to the destination apparatus 14. The one or more communications media may include a wireless and/or wired communications medium, for example, a radio frequency (RF) spectrum or one or more physical transmission lines. The one or more communications media may form a part of a packet-based network (for example, a local area network, a wide area network, or a global network (such as the Internet)). The one or more communications media may include a router, a switch, a base station, or another device that facilitates communication between the source apparatus 12 and the destination apparatus 14.

In another instance, the channel 16 may include a storage medium for storing the coded video data generated by the source apparatus 12. In this instance, the destination apparatus 14 may access the storage medium through magnetic disk access or card access. The storage medium may include a plurality of types of local-access data storage media, for example, a BLU_RAY disc, a Digital Versatile Disc (DVD), a Compact Disc Read Only Memory (CD-ROM), a flash memory, or another proper digital storage medium for storing coded video data.

In another instance, the channel 16 may include a file server or another intermediate storage apparatus for storing the coded video data generated by the source apparatus 12. In this instance, the destination apparatus 14 may access, through streaming transmission or download, the coded video data stored in the file server or in the another intermediate storage apparatus. The file server may be a type of server capable of storing the coded video data and transmitting the coded video data to the destination apparatus 14. The file server includes a web server (for example, used for a website), a File Transfer Protocol (FTP) server, a network attached storage (NAS) apparatus, and a local disk drive.

The destination apparatus 14 may access the coded video data through a standard data connection (for example, an Internet connection). An instance type of the data connection includes a radio channel (for example, a Wireless Fidelity (Wi-Fi) connection) or a wired connection (such as a digital subscriber line (DSL) or a cable modem) suitable for accessing the coded video data stored in the file server, or a combination of the radio channel and the wired connection. Transmission of the coded video data from the file server may be streaming transmission, download transmission, or a combination of streaming transmission and download transmission.

Technologies of this application are not limited to being used in a wireless application scenario. For example, the technologies may be applied to video coding and decoding that supports a plurality of multimedia applications, such as the following applications over-the-air television broadcasting, cable television transmission, satellite television transmission, streaming-transmission video transmitting (for example, through the Internet), coding of video data stored in a data storage medium, decoding of video data stored in a data storage medium, or another application. In some instances, the video coding and decoding system 10 may support, through configuration, one-way or two-way video transmitting, so as to support applications, such as video streaming transmission, video playing, video broadcasting, and/or video telephony.

In the instance in FIG. 2, the source apparatus 12 includes a video source 18, a video coder 20, and an output interface 22. In some instances, the output interface 22 may include a modulator/demodulator (modem) and/or a transmitter. The video source 18 may include a video capturing apparatus (for example, a video camera), video archives including previously captured video data, a video input interface for receiving video data from a video content provider, a computer graphics system for generating video data, or a combination of the foregoing video data sources.

The video coder 20 can code video data from the video source 18. In some instances, the source apparatus 12 directly transmits coded video data to the destination apparatus 14 through the output interface 22. Alternatively, the coded video data may be stored in a storage medium or the file server, so that the destination apparatus 14 accesses the coded video data later for decoding and/or playing.

In the instance in FIG. 2, the destination apparatus 14 includes an input interface 28, a video decoder 30, and a display apparatus 32. In some instances, the input interface 28 includes a receiver and/or a modem. The input interface 28 can receive the coded video data through the channel 16. The display apparatus 32 may be integrated into the destination apparatus 14 or may be outside the destination apparatus 14. Usually, the display apparatus 32 displays decoded video data. The display apparatus 32 may include a plurality of display apparatuses, for example, a liquid crystal display (LCD), a plasma display, an organic light-emitting diode (OLED) display, or another type of display apparatus.

The video coder 20 and the video decoder 30 may perform operations based on a video compression standard (for example, a highly-efficient video coding and decoding standard H.265), and may follow a High Efficiency Video Coding (HEVC) test model (HM). A text description International Telecommunication Unit-Telecommunication Standardization Sector (ITU-TH) ITU-TH.265 (V3) (April 2015) of the H.265 standard was released on Apr. 29, 2015, and can be downloaded from https://handle.itu.int/11.1002/1000/12455, which is incorporated herein by reference in its entirety.

Alternatively, the video coder 20 and the video decoder 30 may perform operations based on another dedicated standard or another industry standard. The standard includes ITU-TH.261, ISO/IECMPEG-1Visual, ITU-TH.262 or ISO/IECMPEG-2Visual, ITU-TH.263, ISO/IECMPEG-4Visual, and ITU-TH.264 (also referred to as ISO/IECMPEG-4AVC), and includes Scalable Video Coding (SVC) and Multiview Video Coding (MVC) extension. It should be understood that the technologies of this application are not limited to any specific coding and decoding standards or technologies.

In addition, FIG. 2 is only an instance, and the technologies of this application may be applied to a video coding and decoding application (such as single-sided video coding or video decoding) that does not necessarily include any data communication between a coding apparatus and a decoding apparatus. In another instance, data is retrieved from a local memory, and transmitted in a streaming way through a network, or the data is operated in a similar manner. The coding apparatus may code data and store the data in the memory, and/or the decoding apparatus may retrieve the data from the memory and decode the data. In many instances, coding and decoding are performed using a plurality of apparatuses that do not communicate with each other but only code data and store the data in the memory, and/or retrieve the data from a memory and decode the data.

The video coder 20 and the video decoder 30 each may be implemented as any one of a plurality of proper circuits, such as one or more microprocessors, a digital signal processor (DSP), an application-specific integrated circuit (ASIC), a field programmable gate array (FPGA), discrete logic, hardware, or any combination thereof. If the technologies are partially or totally implemented using software, the apparatuses may store an instruction of the software in a proper non-transitory computer-readable storage medium, and one or more processors may be configured to execute an instruction in hardware, to execute the technologies of this application. Any one (including the hardware, the software, and a combination of the hardware and the software) of the foregoing may be considered as one or more processors. The video coder 20 and the video decoder 30 each may be included in one or more coders or decoders, and any one thereof may be integrated as a combination-type coder/decoder (codec (CODEC)) part into another apparatus.

In this application, it may generally indicate that the video coder 20 “sends, using a signal”, information to another apparatus (for example, the video decoder 30). The term “sends, using a signal” generally indicates a syntactic element and/or sending of coded video data. The sending may occur in real time or almost in real time. Alternatively, the communication may occur in a time span, for example, may occur when a syntactic element is stored in a computer readable storage medium during coding using binary data to be obtained after coding, and the syntactic element may be retrieved by the decoding apparatus anytime after being stored in the medium.

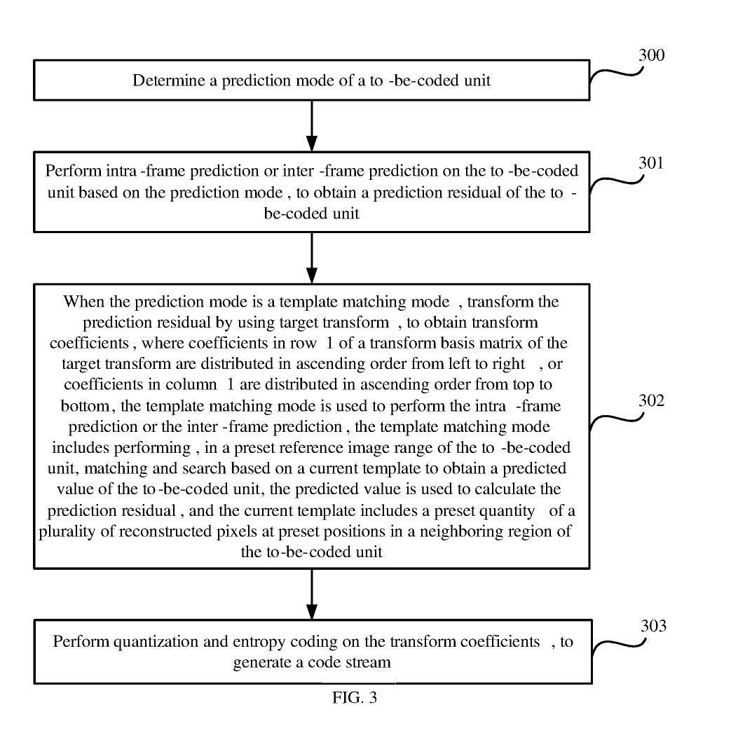

As shown in FIG. 3, an embodiment of this application provides a coding method based on template matching. A specific procedure is shown below.

Step 300: Determine a prediction mode of a to-be-coded unit.

The to-be-coded unit in this application may also be referred to as a to-be-coded block.

Step 301: Perform intra-frame prediction or inter-frame prediction on the to-be-coded unit based on the prediction mode, to obtain a prediction residual of the to-be-coded unit.

Step 302: When the prediction mode is a template matching mode, transform the prediction residual using target transform, to obtain transform coefficients, where coefficients in a row 1 of a transform basis matrix of the target transform are distributed in ascending order from top to bottom, or coefficients in column 1 are distributed from top to bottom, the template matching mode is used to perform the intra-frame prediction or the inter-frame prediction, the template matching mode includes performing, in a preset reference image range of the to-be-coded unit, matching and search based on a current template to obtain a predicted value of the to-be-coded unit, the predicted value is used to calculate the prediction residual, and the current template includes a preset quantity of a plurality of reconstructed pixels at preset positions in a neighboring region of the to-be-coded unit.

It should be noted that the prediction based on template matching may be applied to both intra-frame coding and inter-frame coding. When template matching is applied to intra-frame prediction, a predicted value is usually obtained from a preset quantity of a plurality of reconstructed pixels at preset positions in a neighboring region of the to-be-coded unit using a template matching method. In this case, template matching is performed inside a current coded image to obtain the predicted value of the to-be-coded unit. When template matching is applied to inter-frame prediction, motion information of a coded reference frame is obtained using a template matching method, and the predicted value of the to-be-coded unit is obtained using the motion information.

When the prediction mode is the template matching mode, FIG. 4 is a schematic diagram of statistical energy distribution of a template matching-based prediction residual of a to-be-coded unit whose size is 8×8. It can be learned from FIG. 4 that, energy at an upper left corner of the to-be-coded unit is relatively low, and energy at a lower right corner of the to-be-coded unit is relatively high, energy gradually increases from left to right, and energy gradually increases from top to bottom.

This energy distribution is a result resulting from prediction based on template matching. A template is located in a neighboring region at an upper left corner of the current to-be-coded unit. For pixel points in the to-be-coded unit, a pixel point closer to the template has stronger motion correlation, prediction is more accurate, and energy of a prediction residual is lower, and a pixel farther away from the template has weaker motion correlation, prediction is less accurate, and energy of a prediction residual is higher.

It can be learned that, based on an energy distribution feature of the template matching-based prediction residual, the coefficients in row 1 of the transform basis matrix of the selected target transform are distributed in ascending order from left to right, or the coefficients in column 1 are distributed in ascending order from top to bottom.

A transform basis matrix of DST-VII (DST-VII, DST-VII) transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

A basis function T0(j) of the DST-VII transform conforms to an ascending law (i=0, j=0, . . . , N−1), and conforms to the energy distribution of the template matching-based prediction residual. Therefore, spatial correlation and time domain correlation can be better eliminated using the DST-VII transform, and a better transform effect can be obtained.

In a possible implementation, the target transform is the DST-VII transform.

It should be noted that the DST-VII transform herein is merely an example. Other target transform is also applicable to transform of the template matching-based prediction residual, provided that a feature of a basis function of the other target transform conforms to the energy distribution feature of the template matching-based prediction residual.

In an embodiment, when the DST-VII transform is applied to a coding process, a value obtained at a corresponding position with the basis function of the transform is magnified and then a magnified value is rounded. For example, a 4×4 DST-VII transform basis matrix and an 8×8 DST-VII transform basis matrix are expressed in the following matrix forms.

$$DST - VII - 4 \times 4 = [ \begin{matrix}117 & 219 & 296 & 336 \\ 296 & 296 & 0 & - 296 \\ 336 & - 117 & - 296 & 219 \\ 219 & - 336 & 296 & 177\end{matrix} ]$$

$$DST - VII - 8 \times 8 = ⌊ \begin{matrix}65 & 127 & 185 & 237 & 280 & 314 & 338 & 350 \\ 185 & 314 & 350 & 280 & 127 & - 65 & - 237 & - 338 \\ 280 & 338 & 127 & - 185 & - 350 & - 237 & 65 & 314 \\ 338 & 185 & - 237 & - 314 & 65 & 350 & 127 & - 280 \\ 350 & - 65 & - 338 & 127 & 314 & - 185 & - 280 & 237 \\ 314 & - 280 & - 65 & 338 & - 237 & - 127 & 350 & - 185 \\ 237 & - 350 & 280 & - 65 & - 185 & 338 & - 314 & 127 \\ 127 & - 237 & 314 & - 350 & 338 & - 280 & 185 & - 65\end{matrix} ⌋$$

The foregoing matrices are DST-VII transform basis matrices actually used in existing JEM4 reference software, and the 4×4 matrix is obtained by magnifying, by 512 times, a value obtained at a corresponding position with the DST-VII basis function and then rounding a magnified value. It can be learned that coefficients in row 1 of the foregoing matrices are in ascending order, thereby facilitating elimination of redundant information from a prediction residual having an energy ascending feature.

Transform basis matrices of to-be-coded units of other sizes, such as 16×16, 32×32, and 64×64, or 8×16, 8×32, and 32×16, are similar to the foregoing transform basis matrices and not enumerated one by one.

In an embodiment, the prediction residual may be transformed using the target transform and according to the following expression,

C=T1×I×T2

where I represents a matrix of the prediction residual, T1 represents a first form of the transform basis matrix of the target transform. T2 represents a second form of the transform basis matrix of the target transform, and C represents a matrix of the transform coefficients.

The first form and the second form of the transform basis matrix of the target transform are in a transposed matrix relationship. Alternatively, T2 is an inverse matrix of T1.

During two dimensional (2D) transform in video coding, horizontal transform may be performed first and then vertical transform may be performed, to obtain final transform coefficients. Optionally, during 2D transform in video coding, horizontal transform may be performed first and then vertical transform may be performed, to obtain final transform coefficients.

Optionally, T1×I is first matrix multiplication and may be considered as horizontal transform, and then multiplying T1×I by T2 is second matrix multiplication and may be considered as vertical transform. Alternatively, T1×I may be considered as vertical transform, and then multiplying T1×I by T2 is second matrix multiplication and may be considered as horizontal transform. When the target transform is the DST-VII transform, both the horizontal transform and the vertical transform are the DST-VII transform.

Optionally, when the prediction mode is not the template matching mode, DST or DCT is performed on the prediction residual, to obtain the transform coefficients.

Step 303: Perform quantization and entropy coding on the transform coefficients, to generate a code stream.

It can be learned that, in the coding process, if the prediction mode of the to-be-coded unit is the template matching mode, the template matching-based prediction residual is transformed using the target transform, to obtain the transform coefficients, where the coefficients in row 1 of the transform basis matrix of the target transform are distributed in ascending order from left to right, and quantization and entropy coding are performed on the transform coefficients, to generate the code stream. The energy distribution feature of the template matching-based prediction residual is similar to the feature of the transform basis matrix of the target transform, so that correlation can be well eliminated, and a transform effect and a coding effect can be improved.

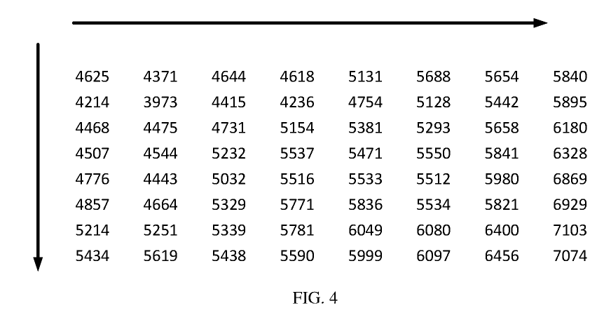

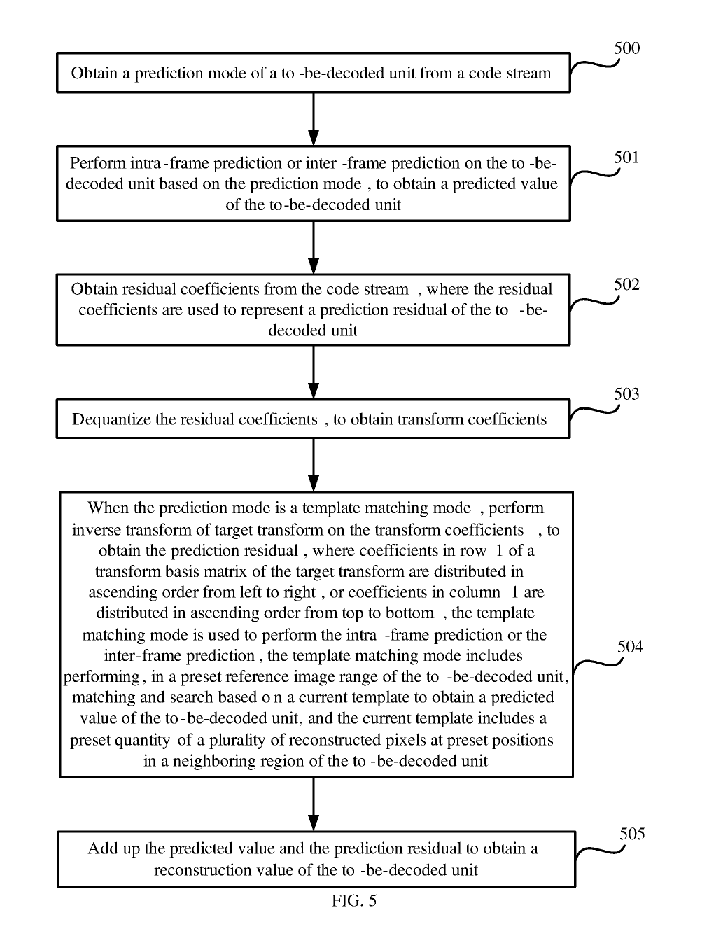

Correspondingly, as shown in FIG. 5, an embodiment of this application provides a decoding method based on template matching. A specific procedure is shown below.

Step 500: Obtain a prediction mode of a to-be-decoded unit from a code stream.

The to-be-decoded unit in this application may also be referred to as a to-be-decoded block.

Step 501: Perform intra-frame prediction or inter-frame prediction on the to-be-decoded unit based on the prediction mode, to obtain a predicted value of the to-be-decoded unit.

Step 502: Obtain residual coefficients from the code stream, where the residual coefficients are used to represent a prediction residual of the to-be-decoded unit.

Step 503: Dequantize the residual coefficients, to obtain transform coefficients.

Step 504: When the prediction mode is a template matching mode, perform inverse transform of target transform on the transform coefficients, to obtain the prediction residual, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-decoded unit, matching and search based on a current template to obtain a predicted value of the to-be-decoded unit, and the current template includes a preset quantity of a plurality of reconstructed pixels at preset positions in a neighboring region of the to-be-decoded unit.

In a possible implementation, the target transform includes DST-VII transform.

A transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

In an embodiment, the inverse transform of the target transform is performed on the transform coefficients according to the following expression: C=T1×I×T2 where I represents a matrix of the transform coefficients, T1 represents a first form of the transform basis matrix of the target transform, T2 represents a second form of the transform basis matrix of the target transform, and C represents a matrix of the prediction residual.

Optionally, the first form and the second form of the transform basis matrix of the target transform are in an inverse matrix relationship. In other words, T2 is an inverse matrix of T1. Optionally, the first form and the second form of the transform basis matrix of the target transform are in a transposed matrix relationship.

Optionally, when the prediction mode is not the template matching mode, inverse transform of DST or inverse transform of DCT is performed on the transform coefficients, to obtain the prediction residual.

Step 505: Add up the predicted value and the prediction residual to obtain a reconstruction value of the to-be-decoded unit.

It can be learned that, in a decoding process, if the prediction mode, obtained from the code stream, of the to-be-decoded unit is the template matching mode, the inverse transform of the target transform is performed on the transform coefficients, to obtain the prediction residual, where the coefficients in row 1 of the transform basis matrix of the target transform are distributed in ascending order from left to right, and the predicted value of the to-be-decoded unit and the prediction residual are added up to obtain the reconstruction value of the to-be-decoded unit. An energy distribution feature of a template matching-based prediction residual is similar to a feature of the transform basis matrix of the target transform, so that correlation can be well eliminated, and a decoding effect can be improved.

As shown in FIG. 6, an embodiment of this application provides a coding method based on template matching. A specific procedure is shown below.

Step 600: Determine a prediction mode of a to-be-coded unit.

The to-be-coded unit in this application may also be referred to as a to-be-coded block.

Step 601: Perform intra-frame prediction or inter-frame prediction on the to-be-coded unit based on the prediction mode, to obtain a prediction residual of the to-be-coded unit.

Step 602: When the prediction mode is a template matching mode and a size of the to-be-coded unit is less than a preset size, transform the prediction residual using target transform, to obtain transform coefficients, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-coded unit, matching and search based on a current template to obtain a predicted value of the to-be-coded unit, the predicted value is used to calculate the prediction residual, and the current template includes a preset quantity of a plurality of reconstructed pixels at preset positions in a neighboring region of the to-be-coded unit.

The preset size includes the following case:
a length and a width of the to-be-coded unit each are 2, 4, 8, 16, 32, 64, 128, or 256, or
a long side of the to-be-coded unit is 2, 4, 8, 16, 32, 64, 128, or 256, or
a short side of the to-be-coded unit is 2, 4, 8, 16, 32, 64, 128, or 256.

The foregoing are possible preset sizes. Certainly, another size may be set. This is not limited in this application.

It should be noted that a size of a target transform matrix of the to-be-coded unit in this application may be the same as or less than the size of the to-be-coded unit.

In video coding, the size of the to-be-coded unit may vary. There are usually square sizes: 4×4, 8×8, 16×16, . . . , 64×64, 128×128, and the like, and there are various non-square sizes such as 4×8, 8×16, 16×8, 4×16, 32×8, . . . . For a relatively small block size, for example, a size of a block is less than 32×32, energy of a prediction residual of the block well presents a feature of gradient energy distribution in FIG. 4, that is, energy increases from top to bottom and from left to right.

In addition, a basis function T0(j) of DST-VII transform conforms to an ascending law (i=0, j=0, . . . , N−1), and conforms to energy distribution of the template matching-based prediction residual. Therefore, spatial correlation and time domain correlation can be better eliminated using the DST-VII transform, and a better transform effect can be obtained.

Therefore, in a possible implementation, when the prediction mode is the template matching mode, and the size of the to-be-coded unit is less than the preset size, the target transform includes DST-VII transform.

A transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

It should be noted that the DST-VII transform herein is merely an example. Other target transform is also applicable to transform of the template matching-based prediction residual, provided that a feature of a basis function of the other target transform conforms to the energy distribution feature of the template matching-based prediction residual.

In an embodiment, when the DST-VII transform is applied to a coding process, a value obtained at a corresponding position with the basis function of the transform is magnified and then a magnified value is rounded. For example, a 4×4 DST-VII transform basis matrix and an 8×8 DST-VII transform basis matrix are expressed in the following matrix forms.

$$DST \text{-} VII \text{-} 4 \times 4 = [ \begin{matrix}117 & 219 & 296 & 336 \\ 296 & 296 & 0 & - 296 \\ 336 & - 117 & - 296 & 219 \\ 219 & - 336 & 296 & - 117\end{matrix} ]$$

$$DST \text{-} VII \text{-} 8 \times 8 = [ \begin{matrix}65 & 127 & 185 & 237 & 280 & 314 & 338 & 350 \\ 185 & 314 & 350 & 280 & 127 & - 65 & - 237 & - 338 \\ 280 & 338 & 127 & - 185 & - 350 & - 237 & 65 & 314 \\ 338 & 185 & - 237 & - 314 & 65 & 350 & 127 & - 280 \\ 350 & - 65 & - 338 & 127 & 314 & - 185 & - 280 & 237 \\ 314 & - 280 & - 65 & 338 & - 237 & - 127 & 350 & - 185 \\ 237 & - 350 & 280 & - 65 & - 185 & 338 & - 314 & 127 \\ 127 & - 237 & 314 & - 350 & 338 & - 280 & 185 & - 65\end{matrix} ]$$

The foregoing matrices are DST-VII transform basis matrices actually used in existing JEM4 reference software, and the 4×4 matrix is obtained by magnifying, by 512 times, a value obtained at a corresponding position with the DST-VII basis function and then rounding a magnified value. It can be learned that coefficients in row 1 of the foregoing matrices are in ascending order, thereby facilitating elimination of redundant information from a prediction residual having an energy ascending feature.

In an embodiment, the prediction residual may be transformed using the target transform and according to the following expression:

C=T1×I×T2

where I represents a matrix of the prediction residual, T1 represents a first form of the transform basis matrix of the target transform, T2 represents a second form of the transform basis matrix of the target transform, and C represents a matrix of the transform coefficients.

Optionally, the first form and the second form of the transform basis matrix of the target transform are in an inverse matrix relationship. In other words, T2 is an inverse matrix of T1. Optionally, the first form and the second form of the transform basis matrix of the target transform are in a transposed matrix relationship.

During 2D transform in video coding, horizontal transform may be performed first and then vertical transform may be performed, to obtain final transform coefficients. Optionally, during 2D transform in video coding, horizontal transform may be performed first and then vertical transform may be performed, to obtain final transform coefficients.

Optionally, T1×I is first matrix multiplication and may be considered as horizontal transform, and then multiplying T1×I by T2 is second matrix multiplication and may be considered as vertical transform. Alternatively, T1×I may be considered as vertical transform, and then multiplying T1×I by T2 is second matrix multiplication and may be considered as horizontal transform. When the target transform is the DST-VII transform, both the horizontal transform and the vertical transform are the DST-VII transform.

Optionally, when the prediction mode is not the template matching mode or the size of the to-be-coded unit is not less than the preset size, DCT or DST is performed on the prediction residual, to obtain the transform coefficients.

It is worth mentioning that, because a region far away from a template is relatively large, energy distribution of a residual of a large-sized prediction residual block tends to flatly change in most cases.

A transform basis matrix of DCT-II transform is determined by a basis function of the DCT-II transform, and the basis function of the DCT-II transform is

$${T}_{i} ( j ) = {ω}_{0} \cdot \sqrt{\frac{2}{N}} \cdot cos ( \frac{π \cdot i \cdot ( 2 j + 1 ) }{2 N} ) ,$$

where i and j represent a row index and a column index respectively, N represents a quantity of transform points, and

$${ω}_{0} = \{ \begin{matrix}\sqrt{\frac{2}{N}} & i = 0 \\ 1 & i \neq 0\end{matrix} .$$

A transform basis matrix of DCT-V transform is determined by a basis function of the DCT-V transform, and the basis function of the DCT-V transform is

$${T}_{i} ( j ) = {ω}_{0} \cdot {ω}_{1} \cdot \sqrt{\frac{2}{2 N - 1}} \cdot cos ( \frac{2 π \cdot i \cdot j}{2 N - 1} ) ,$$

where i and j represent a row index and a column index respectively, N represents a quantity of transform points,

$${ω}_{0} = \{ \begin{matrix}\sqrt{\frac{2}{N}} & i = 0 \\ 1 & i \neq 0\end{matrix} , and \\ {ω}_{1} = \{ \begin{matrix}\sqrt{\frac{2}{N}} & j = 0 \\ 1 & j \neq 0\end{matrix} .$$

It can be learned that a basis function T0(j) of the DCT-II transform and a basis function T0(j) of the DCT-V transform each are a constant (j=0, . . . , or N−1), and are suitable for flat residual energy distribution.

Therefore, because a region far away from a template is relatively large, energy distribution of a residual of a large-sized prediction residual block tends to flatly change in most cases. In this case, using adaptive transform of DST-VII or DCT-II is a better choice.

Step 603: Perform quantization and entropy coding on the transform coefficients, to generate a code stream.

It can be learned that, in the coding process, if the prediction mode of the to-be-coded unit is the template matching mode and the size of the to-be-coded unit is less than the preset size, the template matching-based prediction residual is transformed using the target transform, to obtain the transform coefficients, where the coefficients in row 1 of the transform basis matrix of the target transform are distributed in ascending order from left to right, and quantization and entropy coding are performed on the transform coefficients, to generate the code stream. The energy distribution feature of the template matching-based prediction residual is similar to the feature of the transform basis matrix of the target transform, so that correlation can be well eliminated, and a transform effect and a coding effect can be improved.

Correspondingly, as shown in FIG. 7, an embodiment of this application provides a decoding method based on template matching. A specific procedure is shown below.

Step 700: Obtain a prediction mode of a to-be-decoded unit from a code stream.

Step 701: Perform intra-frame prediction or inter-frame prediction on the to-be-decoded unit based on the prediction mode, to obtain a predicted value of the to-be-decoded unit.

Step 702: Obtain residual coefficients from the code stream, where the residual coefficients are used to represent a prediction residual of the to-be-decoded unit.

Step 703: Dequantize the residual coefficients, to obtain transform coefficients.

Step 704: When the prediction mode is a template matching mode and a size of the to-be-decoded unit is less than a preset size, perform inverse transform of target transform on the transform coefficients, to obtain the prediction residual, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-decoded unit, matching and search based on a current template to obtain a predicted value of the to-be-decoded unit, and the current template includes a preset quantity of a plurality of reconstructed pixels at preset positions in a neighboring region of the to-be-decoded unit.

It should be noted that a size of the to-be-decoded unit in this application may be the same as the preset size, or may be less than the preset size.

The preset size includes the following case:
a length and a width of the to-be-decoded unit each are 2, 4, 8, 16, 32, 64, 128, or 256, or
a long side of the to-be-decoded unit is 2, 4, 8, 16, 32, 64, 128, or 256, or
a short side of the to-be-decoded unit is 2, 4, 8, 16, 32, 64, 128, or 256.

The foregoing are possible preset sizes. Certainly, another size may be set. This is not limited in this application.

In a possible implementation, the target transform includes DST-VII transform.

A transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

In an embodiment, the inverse transform of the target transform is performed on the transform coefficients according to the following expression:

C=T×I×T2

where I represents a matrix of the transform coefficients, T1 represents a first form of the transform basis matrix of the target transform, T2 represents a second form of the transform basis matrix of the target transform, and C represents a matrix of the prediction residual.

Optionally, the first form and the second form of the transform basis matrix of the target transform are in an inverse matrix relationship. In other words, T2 is an inverse matrix of T1. Optionally, the first form and the second form of the transform basis matrix of the target transform are in a transposed matrix relationship.

Optionally, when the prediction mode is not the template matching mode or the size of the to-be-decoded unit is not less than the preset size, an index is obtained from the code stream, where the index is used to represent that the inverse transform is performed using DST or DCT, and inverse transform of the DST or inverse transform of the DCT is performed on the transform coefficients, to obtain the prediction residual.

Step 705: Add up the predicted value and the prediction residual to obtain a reconstruction value of the to-be-decoded unit.

It can be learned that, in a decoding process, if the prediction mode, obtained from the code stream, of the to-be-decoded unit is the template matching mode and the size of the to-be-decoded unit is less than the preset size, the inverse transform of the target transform is performed on the transform coefficients, to obtain the prediction residual, where the coefficients in row 1 of the transform basis matrix of the target transform are distributed in ascending order from left to right, and the predicted value of the to-be-decoded unit and the prediction residual are added up to obtain the reconstruction value of the to-be-decoded unit. An energy distribution feature of a template matching-based prediction residual is similar to a feature of the transform basis matrix of the target transform, so that correlation can be well eliminated, and a decoding effect can be improved.

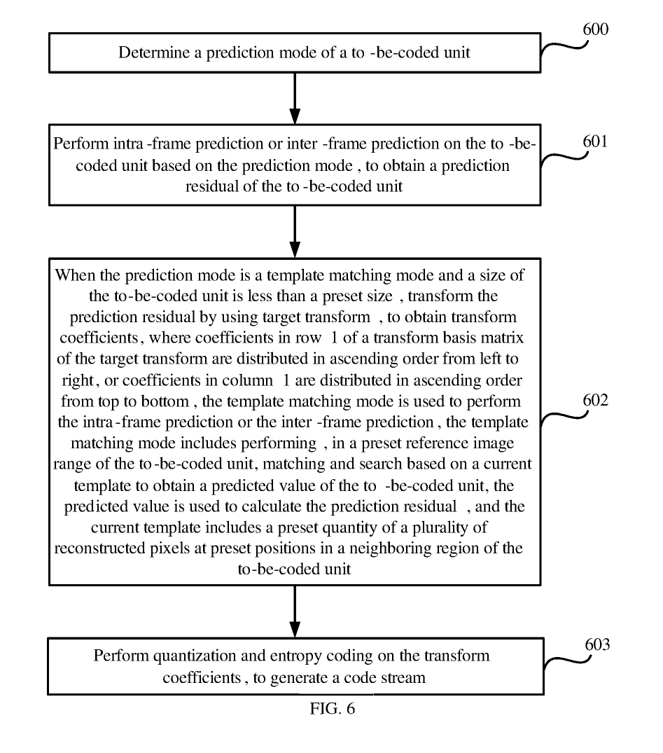

Based on the foregoing embodiments, as shown in FIG. 8, an embodiment of this application provides a coding apparatus 800 based on template matching. As shown in FIG. 8, the apparatus 800 includes a determining unit 801, a prediction unit 802, a transform unit 803, and a coding unit 804.

The determining unit 801 is configured to determine a prediction mode of a to-be-coded unit.

The prediction unit 802 is configured to perform intra-frame prediction or inter-frame prediction on the to-be-coded unit based on the prediction mode, to obtain a prediction residual of the to-be-coded unit.

The transform unit 803 is configured to, when the prediction mode is a template matching mode, transform the prediction residual using target transform, to obtain transform coefficients, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-coded unit, matching and search based on a current template to obtain a predicted value of the to-be-coded unit, the predicted value is used to calculate the prediction residual, and the current template includes a preset quantity of a plurality of reconstructed pixels at preset positions in a neighboring region of the to-be-coded unit.

The coding unit 804 is configured to perform quantization and entropy coding on the transform coefficients, to generate a code stream.

Optionally, the target transform includes DST-VII transform.

A transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

In an embodiment, the transform unit 803 transforms the prediction residual using the target transform and according to the following expression:

C=T1×I×T2

where I represents a matrix of the prediction residual, T1 represents a first form of the transform basis matrix of the target transform, T2 represents a second form of the transform basis matrix of the target transform, and C represents a matrix of the transform coefficients.

Optionally, the first form and the second form are in a transposed matrix relationship.

Optionally, the transform unit 803 is further configured to, when the prediction mode is not the template matching mode, perform DST or DCT on the prediction residual, to obtain the transform coefficients.

It should be noted that, for functional implementation of the units of the apparatus 800 in this embodiment of this application and manners of interaction between the units, further refer to descriptions of related method embodiments. Details are not described herein again.

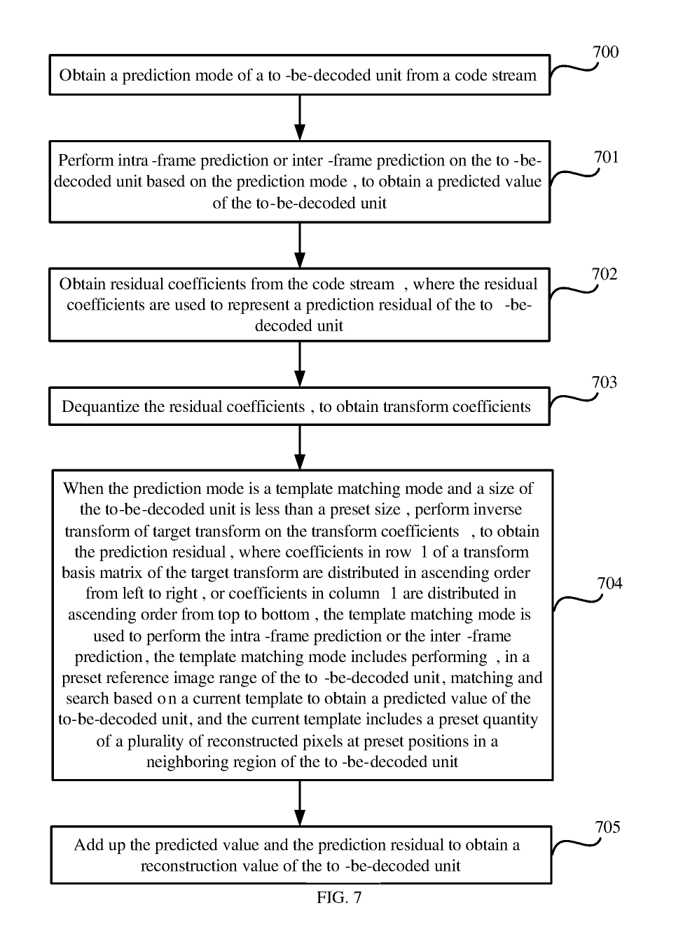

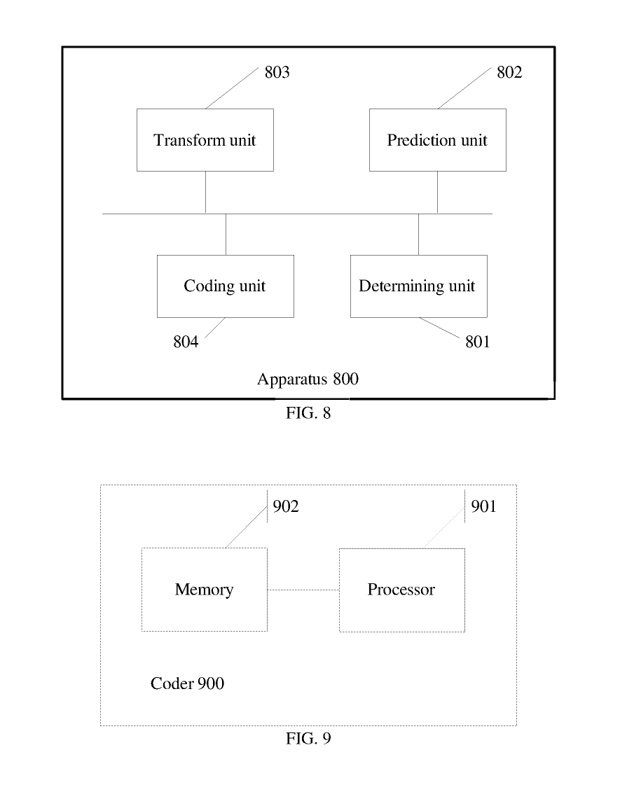

Based on a same application idea, as shown in FIG. 9, an embodiment of this application further provides a coder 900. As shown in FIG. 9, the coder 900 includes a processor 901 and a memory 902. Program code for executing the solutions of the present application is stored in the memory 902, and is used to instruct the processor 901 to perform the coding method based on template matching shown in FIG. 3.

In the present application, code corresponding to the method shown in FIG. 3 may be solidified into a chip by designing and programming the processor, so that when the chip is running, the chip can perform the method shown in FIG. 3.

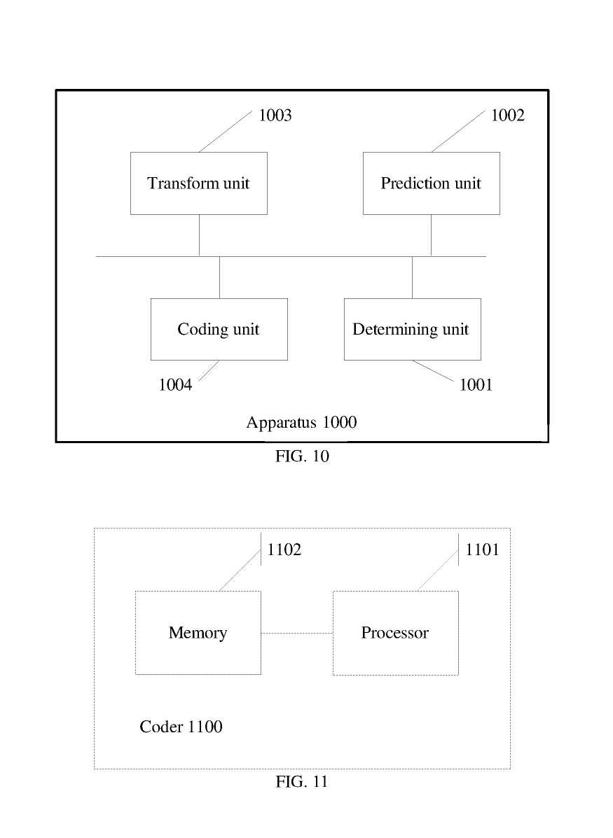

Based on the foregoing embodiments, as shown in FIG. 10, an embodiment of this application provides a coding apparatus 1000 based on template matching. As shown in FIG. 10, the apparatus 1000 includes a determining unit 1001, a prediction unit 1002, a transform unit 1003, and a coding unit 1004.

The determining unit 1001 is configured to determine a prediction mode of a to-be-coded unit.

The prediction unit 1002 is configured to perform intra-frame prediction or inter-frame prediction on the to-be-coded unit based on the prediction mode, to obtain a prediction residual of the to-be-coded unit.

The transform unit 1003 is configured to, when the prediction mode is a template matching mode and a size of the to-be-coded unit is less than a preset size, transform the prediction residual using target transform, to obtain transform coefficients, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-coded unit, matching and search based on a current template to obtain a predicted value of the to-be-coded unit, the predicted value is used to calculate the prediction residual, and the current template includes a preset quantity of a plurality of reconstructed pixels at preset positions in a neighboring region of the to-be-coded unit.

The coding unit 1004 is configured to perform quantization and entropy coding on the transform coefficients, to generate a code stream.

Optionally, the target transform includes DST-VII transform.

A transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

Optionally, the transform unit 1003 is further configured to when the prediction mode is not the template matching mode or the size of the to-be-coded unit is not less than the preset size, perform DCT or DST on the prediction residual, to obtain the transform coefficients.

For functional implementation of the units of the apparatus 1000 in this embodiment of this application and manners of interaction between the units, further refer to descriptions of related method embodiments. Details are not described herein again.

It should be understood that, division of the units in the apparatus 1000 and the apparatus 800 is merely division of logical functions, and during actual implementation, some or all of the units may be integrated into one physical entity, or the units may be physically separated. For example, the units may be processing components that are independently disposed, or may be integrated into one chip of a coding device for implementation. In addition, the units may be alternatively stored, in a form of program code, in a storage component of a coder, where the program code is invoked by a processing component of a coding device to execute the functions of the units. In addition, the units may be integrated together, or may be independently implemented. The processing component herein may be an integrated circuit chip having a signal processing capability. During implementation, steps in the foregoing methods or the foregoing units may be implemented using an integrated logical circuit of hardware in the processing component, or using instructions in a form of software. The processing component may be a general-purpose processor, for example, a central processing unit (CPU), or may be one or more integrated circuits configured to perform the foregoing method, for example, one or more ASIC, one or more DSPs, or one or more FPGAs.

Based on a same application idea, as shown in FIG. 11, an embodiment of this application further provides a coder 1100. As shown in FIG. 11, the coder 1100 includes a processor 1101 and a memory 1102. Program code for executing the solutions of the present application is stored in the memory 1102, and is used to instruct the processor 1101 to perform the coding method based on template matching shown in FIG. 3.

In the present application, code corresponding to the method shown in FIG. 6 may be solidified into a chip by designing and programming the processor, so that when the chip is running, the chip can perform the method shown in FIG. 6.

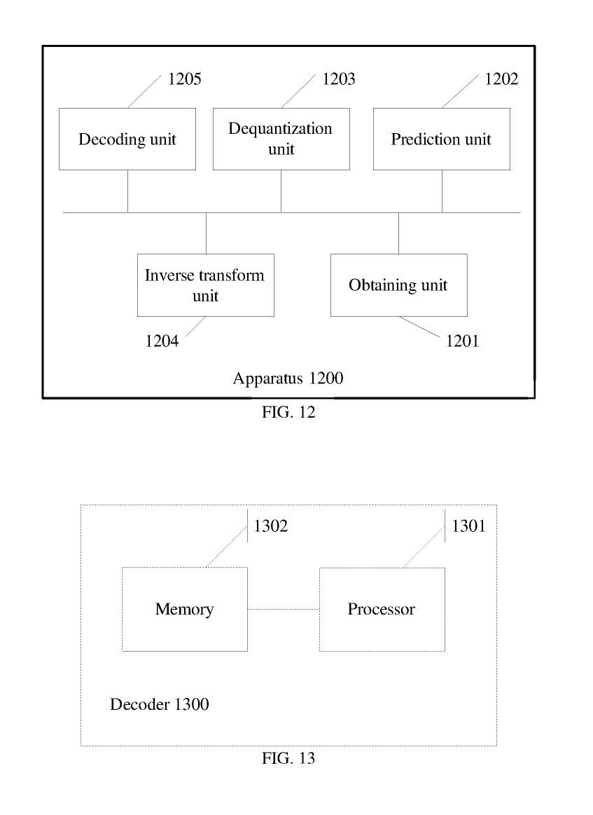

Based on the foregoing embodiments, as shown in FIG. 12, an embodiment of this application provides a decoding apparatus 1200 based on template matching. As shown in FIG. 12, the apparatus 1200 includes an obtaining unit 1201, a prediction unit 1202, a dequantization unit 1203, an inverse transform unit 1204, and a decoding unit 1205.

The obtaining unit 1201 is configured to obtain a prediction mode of a to-be-decoded unit from a code stream.

The prediction unit 1202 is configured to perform intra-frame prediction or inter-frame prediction on the to-be-decoded unit based on the prediction mode, to obtain a predicted value of the to-be-decoded unit.

The obtaining unit 1201 is further configured to obtain residual coefficients from the code stream, where the residual coefficients are used to represent a prediction residual of the to-be-decoded unit.

The dequantization unit 1203 is configured to dequantize the residual coefficients, to obtain transform coefficients.

The inverse transform unit 1204 is configured to, when the prediction mode is a template matching mode, perform inverse transform of target transform on the transform coefficients, to obtain the prediction residual, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-decoded unit, matching and search based on a current template to obtain a predicted value of the to-be-decoded unit, and the current template includes a preset quantity of a plurality of reconstructed pixels at preset positions in a neighboring region of the to-be-decoded unit.

The decoding unit 1205 is configured to add up the predicted value and the prediction residual to obtain a reconstruction value of the to-be-decoded unit.

Optionally, the target transform includes DST-VII transform.

A transform basis matrix of the DST-VI transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

Optionally, the inverse transform unit 1204 performs the inverse transform of the target transform on the transform coefficients according to the following expression:

C=T×I×T2

where I represents a matrix of the transform coefficients, T1 represents a first form of the transform basis matrix of the target transform, T2 represents a second form of the transform basis matrix of the target transform, and C represents a matrix of the prediction residual.

Optionally, the first form and the second form are in a transposed matrix relationship.

Optionally, the inverse transform unit 1204 is further configured to, when the prediction mode is not the template matching mode, perform inverse transform of DST or inverse transform of DCT on the transform coefficients, to obtain the prediction residual.

For functional implementation of the units of the apparatus 1200 in this embodiment of this application and manners of interaction between the units, further refer to descriptions of related method embodiments. Details are not described herein again.

Based on a same application idea, an embodiment of this application further provides a decoder 1300. As shown in FIG. 13, the decoder 1300 includes a processor 1301 and a memory 1302. Program code for executing the solutions of the present application is stored in the memory 1302, and is used to instruct the processor 1301 to perform the decoding method shown in FIG. 5.

In the present application, code corresponding to the method shown in FIG. 5 may be solidified into a chip by designing and programming the processor, so that when the chip is running, the chip can perform the method shown in FIG. 5.

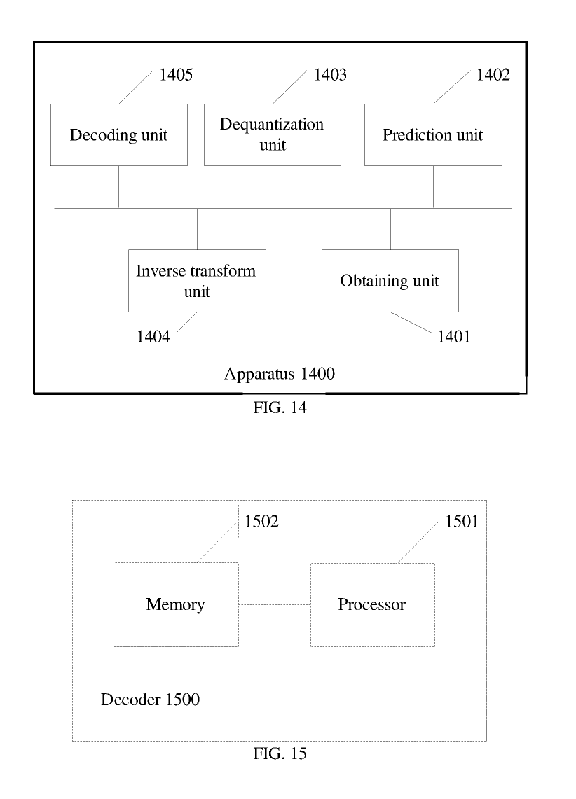

Based on the foregoing embodiments, as shown in FIG. 14, an embodiment of this application provides a decoding apparatus 1400 based on template matching. As shown in FIG. 14, the apparatus 1400 includes an obtaining unit 1401, a prediction unit 1402, a dequantization unit 1403, an inverse transform unit 1404, and a decoding unit 1405.

The obtaining unit 1401 is configured to obtain a prediction mode of a to-be-decoded unit from a code stream.

The prediction unit 1402 is configured to perform intra-frame prediction or inter-frame prediction on the to-be-decoded unit based on the prediction mode, to obtain a predicted value of the to-be-decoded unit.

The prediction unit 1402 is further configured to obtain residual coefficients from the code stream, where the residual coefficients are used to represent a prediction residual of the to-be-decoded unit.

The dequantization unit 1403 is configured to dequantize the residual coefficients, to obtain transform coefficients.

The inverse transform unit 1404 is configured to, when the prediction mode is a template matching mode and a size of the to-be-decoded unit is less than a preset size, perform inverse transform of target transform on the transform coefficients, to obtain the prediction residual, where coefficients in row 1 of a transform basis matrix of the target transform are distributed in ascending order from left to right, or coefficients in column 1 are distributed in ascending order from top to bottom, the template matching mode is used to perform the intra-frame prediction or the inter-frame prediction, the template matching mode includes performing, in a preset reference image range of the to-be-decoded unit, matching and search based on a current template to obtain a predicted value of the to-be-decoded unit, and the current template includes a preset quantity of a plurality of reconstructed pixels at preset positions in a neighboring region of the to-be-decoded unit.

The decoding unit 1405 is configured to add up the predicted value and the prediction residual to obtain a reconstruction value of the to-be-decoded unit.

Optionally, the target transform includes DST-VII transform.

A transform basis matrix of the DST-VII transform is determined by a basis function of the DST-VII transform, and the basis function of the DST-VII transform is

$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$

where i and j represent a row index and a column index respectively, and N represents a quantity of transform points.

Optionally, the inverse transform unit 1404 performs the inverse transform of the target transform on the transform coefficients according to the following expression:

C=T×I×T2

where I represents a matrix of the transform coefficients, T1 represents a first form of the transform basis matrix of the target transform, T2 represents a second form of the transform basis matrix of the target transform, and C represents a matrix of the prediction residual.

Optionally, the first form and the second form are in a transposed matrix relationship.

Optionally, the inverse transform unit 1404 is further configured to, when the prediction mode is not the template matching mode or the size of the to-be-decoded unit is not less than the preset size, perform inverse transform of DST or inverse transform of DCT on the transform coefficients, to obtain the prediction residual.

Optionally, the obtaining unit 1401 is further configured to, before the inverse transform of the DST or the inverse transform of the DCT is performed on the transform coefficients, obtain an index from the code stream, where the index is used to represent that the inverse transform is performed using the DST or the DCT.

Optionally, the preset size includes the following case:
a length and a width of the to-be-decoded unit each are 2, 4, 8, 16, 32, 64, 128, or 256, or
a long side of the to-be-decoded unit is 2, 4, 8, 16, 32, 64, 128, or 256, or
a short side of the to-be-decoded unit is 2, 4, 8, 16, 32, 64, 128, or 256.

For functional implementation of the units of the apparatus 1400 in this embodiment of this application and manners of interaction between the units, further refer to descriptions of related method embodiments. Details are not described herein again.

It should be understood that, division of the units in the apparatus 1200 and the apparatus 1400 is merely division of logical functions, and during actual implementation, some or all of the units may be integrated into one physical entity, or the units may be physically separated. For example, the units may be processing components that are independently disposed, or may be integrated into one chip of a decoding device for implementation. In addition, the units may be alternatively stored, in a form of program code, in a storage component of a decoding device, where the program code is invoked by a processing component of the decoding device to execute the functions of the units. In addition, the units may be integrated together, or may be independently implemented. The processing component herein may be an integrated circuit chip having a signal processing capability. During implementation, steps in the foregoing methods or the foregoing units may be implemented using an integrated logical circuit of hardware in the processing component, or using instructions in a form of software. The processing component may be a general-purpose processor, for example, a CPU, or may be one or more integrated circuits configured to perform the foregoing method, for example, one or more ASIC, one or more DSPs, or one or more FPGA.

Based on a same application idea, an embodiment of this application further provides a decoder 1500. As shown in FIG. 15, the decoder 1500 includes a processor 1501 and a memory 1502. Program code for executing the solutions of the present application is stored in the memory 1502, and is used to instruct the processor 1501 to perform the decoding method shown in FIG. 7.

In the present application, code corresponding to the method shown in FIG. 7 may be solidified into a chip by designing and programming the processor, so that when the chip is running, the chip can perform the method shown in FIG. 7.

It may be understood that the processors in the coder 900, the coder 1100, the decoder 1300, and the decoder 1500 in the embodiments of the present application may be one CPU, one DSP, or one ASIC, or one or more integrated circuits configured to control execution of programs of the solutions of the present application. One or more memories included in a computer system may be a read-only memory (ROM) or another type of static storage device that can store static information and an instruction, a random access memory (RAM) or another type of dynamic storage device that can store information and an instruction, or a magnetic disk memory. The memories are connected to the processors using a bus or using dedicated connection lines.

Persons of ordinary skill in the art may understand that some or all of the steps in the methods of the foregoing embodiments may be implemented by a program instructing a processor. The program may be stored in a computer readable storage medium. The storage medium may be a non-transitory medium, for example, a random-access memory, a read-only memory, a flash memory, a hard disk, a solid state drive, a magnetic tape, a floppy disk, an optical disc, or any combination thereof.

This application is described with reference to the flowcharts and the block diagrams of the methods and the devices in the embodiments of this application. It should be understood that computer program instructions may be used to implement each process and each block in the flowcharts and the block diagrams and a combination of a process and a block in the flowcharts and the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts or in one or more blocks in the block diagrams.

What is claimed is:

1. A decoding method based on template matching, comprising:
obtaining a prediction mode of a to-be-decoded unit from a code stream;
performing intra-frame prediction or inter-frame prediction on the to-be-decoded unit based on the prediction mode to obtain a predicted value of the to-be-decoded unit;
obtaining residual coefficients used to represent a prediction residual of the to-be-decoded unit from the code stream;
dequantizing the residual coefficients to obtain transform coefficients;
performing inverse transform of a target transform on the transform coefficients in response to the prediction mode being a template matching mode to obtain the prediction residual, wherein coefficients in row 1 of a transform basis matrix of the target transform are distributed in ascending order from left to right, or coefficients in column 1 of the transform basis matrix of the target transform are distributed in ascending order from top to bottom, wherein the template matching mode is used to perform the intra-frame prediction or the inter-frame prediction, wherein the template matching mode comprises performing, in a preset reference image range of the to-be-decoded unit, matching and search based on a current template to obtain a predicted value of the to-be-decoded unit, and wherein the current template comprises a preset quantity of a plurality of reconstructed pixels at preset positions in a neighboring region of the to-be-decoded unit; and
adding up the predicted value and the prediction residual to obtain a reconstruction value of the to-be-decoded unit.

2. The method according to claim 1, wherein the target transform comprises a Discrete Sine Transform (DST) of type VII (DST-VII) transform, wherein the method further comprises determining a transform basis matrix of the DST-VII transform by a basis function of the DST-VII transform, wherein the basis function of the DST-VII transform is
$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$
and wherein i represents a row index, j represents a column index, and N represents a quantity of transform points.

3. The method according to claim 1, wherein performing the inverse transform of the target transform on the transform coefficients comprises performing the inverse transform according to the following expression:
C=T1×I×T2,
wherein I represents a matrix of the transform coefficients, T1 represents a first form of the transform basis matrix of the target transform, T2 represents a second form of the transform basis matrix of the target transform, and C represents a matrix of the prediction residual.

4. The method according to claim 3, wherein the first form and the second form are in a transposed matrix relationship.

5. The method according to claim 1, further comprising performing inverse transform of discrete sine transform (DST) or inverse transform of discrete cosine transform (DCT) on the transform coefficients to obtain the prediction residual in response to the prediction mode not being the template matching mode.

6. A decoding method based on template matching, comprising:
obtaining a prediction mode of a to-be-decoded unit from a code stream;
performing intra-frame prediction or inter-frame prediction on the to-be-decoded unit based on the prediction mode to obtain a predicted value of the to-be-decoded unit;
obtaining residual coefficients used to represent a prediction residual of the to-be-decoded unit from the code stream;
dequantizing the residual coefficients to obtain transform coefficients;
performing inverse transform of a target transform on the transform coefficients in response to the prediction mode being a template matching mode and a size of the to-be-decoded unit being less than a preset size to obtain the prediction residual, wherein coefficients in row 1 of a transform basis matrix of the target transform are distributed in ascending order from left to right, or coefficients in column 1 of the transform basis matrix of the target transform are distributed in ascending order from top to bottom, wherein the template matching mode is used to perform the intra-frame prediction or the inter-frame prediction, wherein the template matching mode comprises performing, in a preset reference image range of the to-be-decoded unit, matching and search based on a current template to obtain a predicted value of the to-be-decoded unit, and wherein the current template comprises a preset quantity of a plurality of reconstructed pixels at preset positions in a neighboring region of the to-be-decoded unit; and
adding up the predicted value and the prediction residual to obtain a reconstruction value of the to-be-decoded unit.

7. The method according to claim 6, wherein the target transform comprises a Discrete Sine Transform (DST) of type VII (DST-VII) transform, wherein a transform basis matrix of the DST-VII transform is determined by a basis function of the DST-VII transform, wherein the basis function of the DST-VII transform is
$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$
wherein i represents a row index, j represents a column index, and N represents a quantity of transform points.

8. The method according to claim 6, wherein performing inverse transform of the target transform on the transform coefficients comprises performing the inverse transform according to the following expression:
C=T×I×T2,
wherein I represents a matrix of the transform coefficients, T1 represents a first form of the transform basis matrix of the target transform, T2 represents a second form of the transform basis matrix of the target transform, and C represents a matrix of the prediction residual.

9. The method according to claim 8, wherein the first form and the second form are in a transposed matrix relationship.

10. The method according to claim 6, further comprising performing inverse transform of discrete sine transform (DST) or inverse transform of discrete cosine transform (DCT) on the transform coefficients to obtain the prediction residual in response to the prediction mode not being the template matching mode or the size of the to-be-decoded unit not being less than the preset size.

11. The method according to claim 10, wherein before the performing inverse transform of DST or inverse transform of DCT on the transform coefficients, the method further comprises obtaining an index used to represent that the inverse transform is performed using the DST or the DCT from the code stream.

12. The method according to claim 6, wherein the preset size comprises at least one of:
a length and a width of the to-be-decoded unit each are 2, 4, 8, 16, 32, 64, 128, or 256; or
a long side of the to-be-decoded unit is 2, 4, 8, 16, 32, 64, 128, or 256; or
a short side of the to-be-decoded unit is 2, 4, 8, 16, 32, 64, 128, or 256.

13. A decoding apparatus based on template matching, comprising:
a non-transitory memory comprising processor-executable instructions; and
a processor coupled to the memory and configured to execute the processor-executable instructions, which cause the processor to be configured to:
obtain a prediction mode of a to-be-decoded unit from a code stream;
perform intra-frame prediction or inter-frame prediction on the to-be-decoded unit based on the prediction mode to obtain a predicted value of the to-be-decoded unit;
obtain residual coefficients used to represent a prediction residual of the to-be-decoded unit from the code stream;
dequantize the residual coefficients to obtain transform coefficients;
perform inverse transform of a target transform on the transform coefficients in response to the prediction mode being a template matching mode to obtain the prediction residual, wherein coefficients in row 1 of a transform basis matrix of the target transform are distributed in ascending order from left to right, or coefficients in column 1 of the transform basis matrix of the target transform are distributed in ascending order from top to bottom, wherein the template matching mode is used to perform the intra-frame prediction or the inter-frame prediction, wherein the template matching mode comprises performing, in a preset reference image range of the to-be-decoded unit, matching and search based on a current template to obtain a predicted value of the to-be-decoded unit, and wherein the current template comprises a preset quantity of a plurality of reconstructed pixels at preset positions in a neighboring region of the to-be-decoded unit; and
add up the predicted value and the prediction residual to obtain a reconstruction value of the to-be-decoded unit.

14. The apparatus according to claim 13, wherein the target transform comprises a Discrete Sine Transform (DST) of type VII (DST-VII) transform, wherein a transform basis matrix of the DST-VII transform is determined by a basis function of the DST-VII transform, wherein the basis function of the DST-VII transform is
$${T}_{i} ( j ) = \sqrt{\frac{4}{2 N + 1}} \cdot sin ( \frac{π \cdot ( 2 i + 1 ) \cdot ( j + 1 )}{2 N + 1} ) ,$$
wherein i represents a row index, j represents a column index, and N represents a quantity of transform points.

15. The apparatus according to claim 13, wherein the processor-executable instructions further cause the processor to be configured to perform the inverse transform of the target transform on the transform coefficients according to the following expression:
C=T×I×T2,
wherein I represents a matrix of the transform coefficients, T1 represents a first form of the transform basis matrix of the target transform, T2 represents a second form of the transform basis matrix of the target transform, and C represents a matrix of the prediction residual.

16. The apparatus according to claim 15, wherein the first form and the second form are in a transposed matrix relationship.

17. The apparatus according to claim 13, wherein the processor-executable instructions further cause the processor to perform inverse transform of discrete sine transform (DST) or inverse transform of discrete cosine transform (DCT) on the transform coefficients to obtain the prediction residual in response to the prediction mode not being the template matching mode.

18. The apparatus according to claim 13, wherein the processor-executable instructions further cause the processor to obtain motion information of the to-be-decoded unit.

19. The apparatus according to claim 13, wherein the template matching mode is applied to intra-frame prediction, and wherein the processor-executable instructions further cause the processor to obtain the predicted value from a preset quantity of a plurality of reconstructed pixels at preset positions in a neighboring region of the to-be-coded unit.

20. The apparatus according to claim 13, wherein the template matching mode is applied to inter-frame prediction, and wherein the processor-executable instructions further cause the processor to obtain motion information of a coded reference frame, wherein the predicted value of the to-be-coded unit is obtained using the motion information.
